(19) United States
(12) Patent Application Publication
(10) Pub. No.: US 2008/0044102 A1
(43) Pub. Date: Feb. 21, 2008

(54) Method and Electronic Device for Detecting a Graphical Object

(75) Inventor: Ahmet Ekin, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/722,886

(22) PCT Filed: Jan. 2, 2006
(86) PCT No.: PCT/IB06/50006

§ 371 Date: Jun. 27, 2007

(30) Foreign Application Priority Data
Jan. 7, 2005 (EP) 05100069.3

(51) Int. Cl. G06K 9/36

(52) U.S. Cl. 382/276

(57) ABSTRACT

The method of detecting a graphical object in an image of the invention comprises determining a first value of a feature in an object region (31, 33, 37, 39) of the image, the object region (31, 33, 37, 39) possibly containing the graphical object, determining a second value of the feature in a reference region (32, 38) of the image, the reference region (32, 38) being unlikely to contain the graphical object, and determining whether the object region (31, 33, 37, 39) contains the graphical object in dependency of a difference between the first value and the second value exceeding a certain threshold. The electronic device comprises electronic circuitry operative to perform the method of the invention.

The invention relates to a method of detecting a graphical object in an image, e.g. a channel logo in a video sequence.

The invention further relates to software for making a programmable device operative to perform a method of detecting a graphical object in an image.

The invention also relates to an electronic device for detecting a graphical object in an image.

The invention further relates to electronic circuitry for use in an electronic device for detecting a graphical object in an image.

An example of such a method is described in U.S. Pat. No. 6,100,941. The method described in U.S. Pat. No. 6,100,941 detects static logos in a video sequence. It uses absolute frame difference values in the four corners of a frame of video. When four corners indicate large numbers of pixels with no-change (measured as having a difference value of zero), the algorithm assumes that those segments correspond to logos. The drawback of the known method is that a logo cannot be detected until there is movement in a scene.

It is a first object of the invention to provide a method of the kind described in the opening paragraph, which can detect a graphical object, e.g. a logo, in a scene without movement.

It is a second object of the invention to provide an electronic device of the kind described in the opening paragraph, which can detect a graphical object, e.g. a logo, in a scene without movement.

The first object is according to the invention realized in that the method comprises the steps of determining a first value of a feature in an object region of the image, the object region possibly containing the graphical object, determining a second value of the feature in a reference region of the image, the reference region being unlikely to contain the graphical object, and determining whether the object region contains the graphical object in dependency of a difference between the first value and the second value exceeding a certain threshold. By modeling a graphical object, e.g. a TV logo or other overlaid graphical object, as a deviation (in some feature space, such as color) from the scene, no temporal (still/animated) assumptions are made and graphical objects can therefore be detected in a scene without movement. Fast detection of a logo is important for some commercial detectors. If a user tunes into a new channel, fast localization of the logo is necessary to be able to provide robust commercial detection performance. Temporal information can additionally be integrated into the logo detector if available.

As an additional advantage, the method of the invention can be used to detect transparent and animated logos. There are several types of logos. With regard to motion characteristic, a logo can be static or animated (either the logo is moving or the color/intensity characteristics of the logo change). In terms of opaqueness, a logo can be opaque or transparent. An overwhelming majority of the existing logo detectors assume logos as static and opaque, or at most mildly transparent. The method of the invention does not. As a further advantage, the method of the invention detects logos that are inserted over a completely stationary segment, such as vertical/horizontal black bars that are used for 16:9 to 4:3 format conversion and logos whose intensity/color characteristics periodically change.

The method of the invention can be used for commercial detection, described in U.S. Pat. No. 6,100,941, and/or for commercial identification, described in US 2003/0091237. U.S. Pat. No. 6,100,941 and US 2003/0091237 are incorporated by reference herein. Detection of TV logos is essential for content understanding and display protection. For the former, the lifespan of TV logos is an invaluable clue to identify commercial segments, because a commercial usually results in the disappearance of channel logos. The latter aims at protecting mostly non-CRT displays from burning in. The burn-in problem refers to the ghostly appearance of long-time static scenes on the display even after the display is turned off. It is caused by permanent deformations in the chemical properties of the display and requires its renewal. Because some or all pixels of a channel logo stay in the same location, logo detection can help localize the operating region of burn-in protection algorithms.

In an embodiment of the method of the invention, the first value is representative of values of a plurality of pixels in the object region and the object region is determined to contain the graphical object in dependency of a difference between at least a certain amount of said values and the second value exceeding the certain threshold. By determining for individual pixels instead of groups of pixels (e.g. histogram values) whether the difference between their value and the second value exceeds the certain threshold, more accurate logo detection can be achieved. Individual pixels whose difference with the second value exceeds the certain threshold are also referred to as outliers.

The method may determine the object region to contain the graphical object in dependency of a spatial distribution of pixels whose values exceed the certain threshold matching a typical distribution of graphical objects. To avoid mistaking other deviations from the scene for graphical objects, the spatial distribution of outliers is verified with typical distributions of graphical object.

The feature may be color. This is advantageous due to the fact that most logos appear in colors that are easily distinguishable from the content.

The second value may represent a probability density function of the reference region. A probability density function (pdf) has proven to be useful to model an entity in some selected feature space, e.g. color or texture.

The second value may represent a non-parametric probability density function of the reference region. Although parametric models are powerful density estimators, they make assumptions about the estimated pdf, such as “normal distribution.” This is not advantageous, because logo features and pdfs change from one channel to another; hence, a non-parametric density estimator is used that does not make any assumption about the shape of the pdf and can model any type of pdf.

A histogram may be used to estimate the probability density function of the reference region. Histograms have proven to be powerful non-parametric density estimators.

The image may comprise at least nine regions, four of the nine regions being corner regions, and the object region may comprise at least one of the four corner regions. The Golden Section Rule, see G. Millerson, The technique of television production, 12th Ed., Focal, New York, March 1990, is a commonly applied cinematic technique by professionals that recommends horizontal and vertical division of the frame in 3:5:3 proportions and positioning the main objects at the intersections of the GSR lines. The inventor has recognized that logos are often placed in the corner regions of a frame if the frame is divided using the Golden Section Rule.

The method may determine the second value for a sub region of the reference region, the object region and the sub region being relatively close to each other. The object region and the reference region are preferably relatively close to each other. If the reference region is large, it is advantageous to use a smaller sub region which is relatively close to the object region. This makes a more accurate comparison of the object region and the reference region possible. If values of individual pixels are compared with the second value, the sub region may be different for different individual pixels. The sub region may be created by giving the values of the pixels in the reference region close to the object region a higher weight or by removing the values of the pixels in the reference region which are not close to the object region.

The second object is according to the invention realized in that the electronic device comprises electronic circuitry operative to determine a first value of a feature in a object region of the image, the object region possibly containing the graphical object, to determine a second value of the feature in a reference region of the image, the reference region being unlikely to contain the graphical object, and to determine that the object region contains the graphical object in dependency of a difference between the first value and the second value exceeding a certain threshold.

These and other aspects of the apparatus of the invention will be further elucidated and described with reference to the drawings, in which:

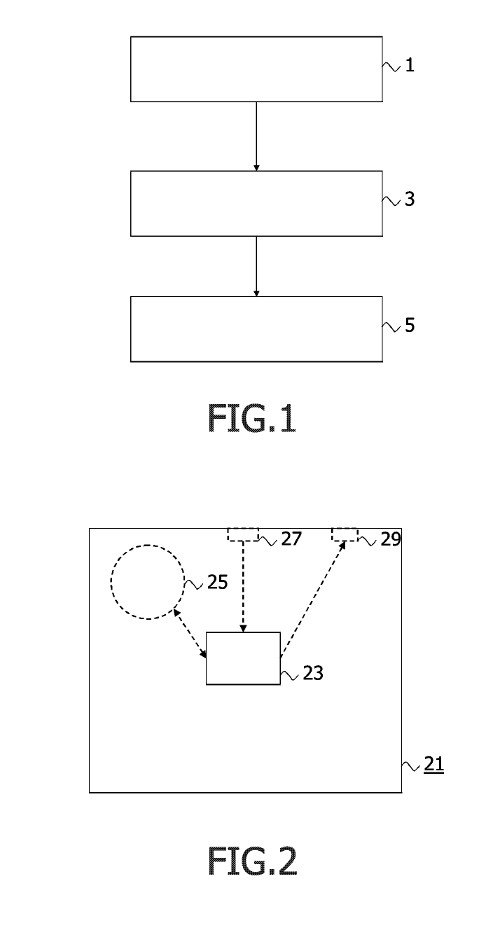

FIG. 1 is a flow diagram of the method of the invention;

FIG. 2 is a block diagram of the electronic device of the invention;

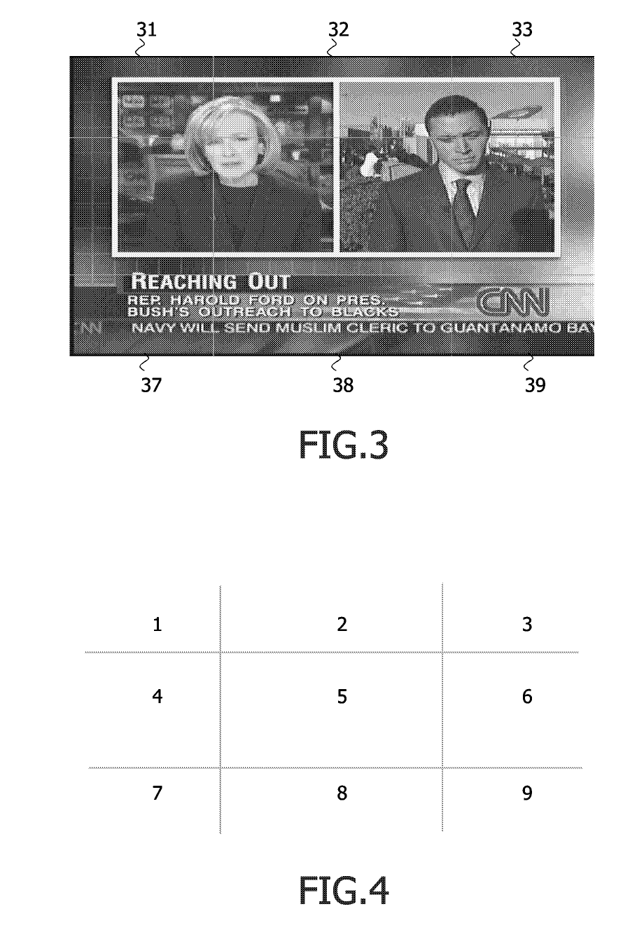

FIG. 3 is an example of an image divided into regions;

FIG. 4 shows the regions used to divide the image of FIG. 3;

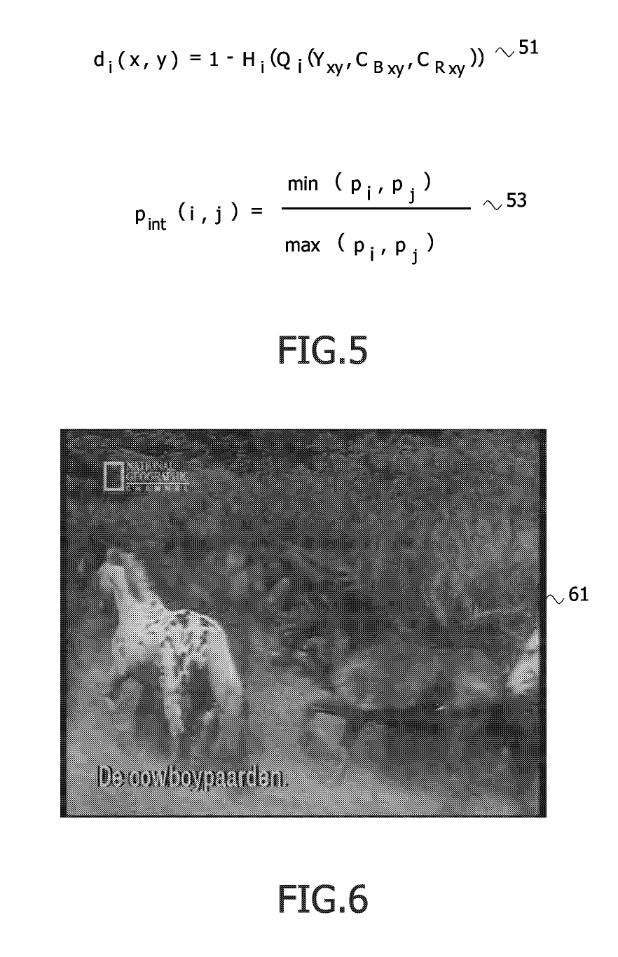

FIG. 5 shows equations used in an embodiment of the method of the invention;

FIG. 6 is an example of a channel logo overlaid on a scene; and

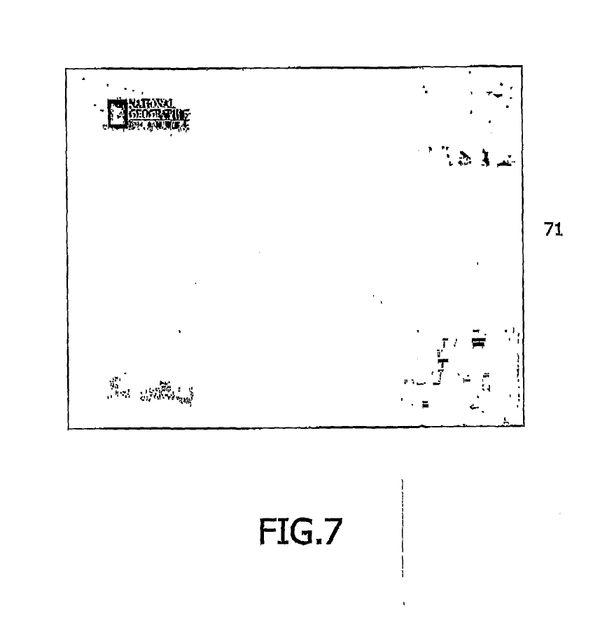

FIG. 7 shows pixels deviating from the scene of FIG. 6.

Corresponding elements within the drawings are identified by the same reference numeral.

The method of detecting a (overlaid) graphical object in an image of the invention, see FIG. 1, comprises steps 1, 3 and 5. Step 1 comprises determining a first value of a feature in an object region of the image, the object region possibly containing the (overlaid) graphical object. Step 3 comprises determining a second value of the feature in a reference region of the image, the reference region being unlikely to contain the (overlaid) graphical object. Step 5 comprises determining whether the object region contains the (overlaid) graphical object in dependency of a difference between the first value and the second value exceeding a certain threshold. The first and/or the second value may be determined by analyzing the image or by processing data received from an electronic device that analyzed the image, the data comprising the first and/or the second value.

In an embodiment of the method, it is assumed that channel logos are positioned in the corners of the frame. For each of the corners, one scene model is estimated by using the neighboring pixels to the respective corners. The Golden Section Rule (GSR) is used to define the corners and their neighbors because GSR is a commonly applied cinematic technique by professionals. GSR recommends horizontal and vertical division of the frame in 3:5:3 proportions and positioning of the main objects at the intersections of the GSR lines (or in the center area for a single object in the scene). The content captured from CNN and shown in FIG. 3 is perfect according to GSR because the heads of the two objects are at the intersections.

As shown in FIG. 4, regions can be numbered from 1 to 9 by raster scanning from top left to bottom right. In most cases, logos are only likely to occur in regions 1, 3, 7, and 9 (regions 31, 33, 37 and 39 of FIG. 3). In this embodiment, the scene models of regions 1 and 3 (regions 31 and 33 of FIG. 3) are computed from the pixels in region 2 (region 32 of FIG. 3), and those of regions 7 and 9 (regions 37 and 39 of FIG. 3) from the pixels in region 8 (region 38 of FIG. 3). None of the pixels from central horizontal regions 4, 5, and 6 are used in this embodiment, but they may be used in an alternative embodiment. For example, a vertical object, such as a human standing and covering regions 3, 6, and 9, can only be differentiated from a logo if pixels from region 6 are used as reference. Both horizontal and vertical central regions may be used together, e.g., 2 reference histograms for each corner region (one from horizontal regions, e.g. 2 and 8, and one from vertical, e.g., 4 and 6).

In this embodiment, however, one scene histogram is defined for each of the four corners (total of four histograms, H₁, H₃, H₇, and H₉ for regions 1, 3, 7, and 9, respectively). The reason for as many as four different histograms is that the color properties change considerably from top to bottom or from left to right. Each histogram is constructed by using the pixels in the center area of the same row. For example, the histograms of region 1 and 3, H₁ and H₃, respectively, use pixels from only region 2 whereas region 7 and 9 histograms, H₇ and H₉, respectively, are constructed from the pixels in region 8. A Gaussian kernel is applied in the horizontal direction to weigh the pixels based on their horizontal distance from the logo regions. 1-D Gaussian kernels are centered at the vertical GSR lines and their 3Gc values are computed to coincide with the horizontal center position of regions 2 and 8. Instead of one for every pixel in the central regions, the pixel weights are added to the color histogram. As a result, each histogram gets decreasing contribution by increasing horizontal distance from the respective corners. Finally, the histograms are normalized. In this embodiment, all lines in the regions 2 and 8 are used.

In an alternative embodiment, a histogram might be constructed by using only close lines to the current pixel. This might be good for hardware implementations. Moreover, this might be a robust approach to eliminate distant pixels having the same color as the logo.

In order to identify individual logo pixels, the deviations from the scene model are determined. One of the methods to identify outliers in a sample is to define the values above the N^{th} percentile as outliers. In this embodiment, the sample space is the color distance of a pixel in the logo areas to the color scene model of the corresponding logo area. In equation 51 of FIG. 5, dᵢ(x, y) is the color distance of the pixel (x, y) with luminance Y_{xy}, and chrominance C_{B}_{_{xy}} and C_{R}_{_{xy}} to the i^{th} scene model Hᵢ. The function Qᵢ( ) computes the i^{th} histogram index of the input luminance-chrominance values, and Hᵢ(k) is the histogram entry of the i^{th} histogram (scene model) computed previously. In principle, the distance values should be sorted to compute the N^{th} percentile and logo pixel candidates are defined to be those above the N^{th} percentile value (threshold). This can be revised, however, due to hardware constraints, for example. To avoid the cost of memory to store all of the distance values, the distances can be quantized and a distance histogram can be used. An equally important reason is that a logo may have more pixels than the number of pixels above the N^{th} percentile. The N^{th} percentile of the quantized distances is first computed; but, when the N^{th} percentile cannot be precisely found because the largest quantized distance has more pixels than (100−N) % of the histogram entry count, all the pixels having the largest quantized distance are defined as outliers.

In an alternative embodiment, for each pixel in regions 1, 3, 7, and 9, the histogram bin value is computed by using the pixel color and then, looking at the entry in the respective histogram, i.e., H₁, H₃, H₇, H₉, respectively. If the entry in the histogram is lower than a pre-determined parameter (threshold), T_MinSceneEntry, the pixel is defined as an outlier (graphics or deviation from the scene). If larger, the pixel is identified as a scene pixel (black). In experiments, the value of 0.01 for T_MinSceneEntry has resulted in a robust performance. The result of this process is a binary image, whereby the deviations from the scene are assigned to white and the scene pixels are assigned to black. FIG. 7 shows an example of an image in which deviations from a scene, see FIG. 6, are assigned to white and the scene pixels are assigned to black. Most of the image shown in FIG. 7 is black, but the channel logo is clearly discernable.

The final stage of the proposed logo detection algorithm is the verification of the spatial distribution of outliers with typical distribution of logo pixels. Depending on the textual content of channel logos, spatial distribution of logo pixels demonstrates variations. Logos that consist of characters, such as the CNN logo in FIG. 3, result in separate, disconnected outlier pixels whereas a pictorial logo usually results in a single blob that is significantly larger than the other outlier blobs. The former type of logos can be detected by using two stage vertical/horizontal projections and the latter type of logos by identifying blobs that have significantly larger size than the other blobs. In both cases, the candidate region is made to conform to certain morphological constraints.

Morphological operations as well as some noise removal techniques are applied to identify logos. First, all the noisy lines that have very high number of white pixels are removed, because these are not expected if a clearly identifiable logo exists in the scene. Furthermore, all the black boundaries are removed that may occur at the frame boundaries. In order to determine if the first or the second type of logo is present, an ROI is computed, which is a rectangle that encompasses large percentage of white pixels (e.g., 80%). In the ROI, the ratio of the largest-sized connected component to the average size of all the other segments is computed. This ratio is called peak ratio and measures the strength of the peak. If this ratio is large, then, the first type of logo is present. Otherwise, the second type of logo is present. Subsequently, some features, such as compactness (filling ratio), aspect ratio, closeness to the boundaries, and size, are computed to find one or more logos in the frame.

In order to detect a logo by using vertical/horizontal projections, the start and the end segments of pixel clusters in the vertical direction are first identified. This stage involves iteratively finding the peak of the histogram, and then computing the vertical start and the end coordinates of the cluster that contains the peak value. After a vertical cluster is identified, the peak of the unassigned vertical projection pixels is found and the process repeats until all vertical clusters are identified. After this first step, horizontal projection of each segment is computed and the horizontal start and end points of the clusters are found. In the final stage, aspect ratio, filling ratio, height, and width of the bounding box about the cluster are verified to detect a logo. The logo usually forms a bounding box whose aspect ratio is greater than one, height greater than 2% of the video height (excluding black bars), and filling ratio greater than 0.5. In order to reduce false detection rate at the expense of miss rate, it is also verified that the region around the bounding box, Bᵢ, is clean. This is accomplished by counting the number of outliers in the area between Bᵢ and the enlarged box whose center is the same as Bᵢ and width and height is 1.25 times the width and height of Bᵢ. The number of maximum allowable outliers in this area is set to a very a low value.

In case the logo is purely pictorial, detection of a blob whose size is significantly larger than all the others is attempted. For that purpose, a connected-component labeling algorithm is first run to find connected regions. After that, the close blobs whose height intersection ratio, p is replaced by height in equation 53 of FIG. 5, or width intersection ratio, p is box width in equation 53 of FIG. 5, is larger than pre-specified threshold value are connected. Object-based dilation is applied by using bounding box features rather than pixel-based dilation, because the latter usually connects pixels that do not belong to the same object and degrades the performance. Finally, the peak saliency ratio, PSR, is computed by dividing the size of the largest blob to the average size of all the other blobs. A PSR value greater than a certain threshold (7 was found to be a good value in our experiments) indicates a logo-candidate blob. Finally, aspect ratio, filling ratio, width, and height parameters of the blob are also verified to finalize the logo decision. In contrast to textual logos, 0.5 is used as aspect ratio threshold for pictorial logos.

Because the proposed algorithm uses only spatial information, animated logos are not different from the static logos. The detection accuracy is usually affected by histogram bin size. After some experimentation, 8×8×8 YCBCR was determined to result in robust performance whereas larger quantization values are very coarse and not discriminative enough. The distance values were quantized to scene models in 1000 intervals and N was defined to be 90^{th} percentile. The distance values were only accepted if they were greater than 0.9. It was also observed that 8×8×8 results in robust performance for RGB whereas 4×4×4 is very coarse and is not discriminative enough. On the other hand, the bin numbers larger than 8×8×8 results in slower processing and larger memory requirements. Although some logos may still be missed with the method of the invention, some of the missed logos can be detected when the scene characteristics become favorable. In the same way, integrating decisions over several frames can eliminate false alarms that usually result from small differently colored objects from the background.

The electronic device 21 for detecting a (overlaid) graphical object in an image of the invention, see FIG. 2, comprises electronic circuitry 23. The electronic circuitry 23 is operative to determine a first value of a feature in an object region of the image, the object region possibly containing the (overlaid) graphical object. The electronic circuitry 23 is also operative to determine a second value of the feature in a reference region of the image, the reference region being unlikely to contain the (overlaid) graphical object. The electronic circuitry 23 is further operative to determine that the object region contains the (overlaid) graphical object in dependency of a difference between the first value and the second value exceeding a certain threshold. The electronic device 21 may be a PC, a TV, a video player and/or recorder, or a mobile phone, for example. The electronic circuitry 23 may be a general-purpose processor, e.g. an Intel Pentium AMD Athlon CPU, or an application-specific processor, e.g. a Philips Trimedia media processor. The electronic device 21 may comprise a storage means 25 for storing images which have been processed, e.g. images from which a logo has been removed, and/or for storing images which have not yet been processed. The storage means may be a hard disk, solid state memory, or an optical disc reader and/or writer, for example. The electronic device 21 may comprise an input 27, e.g. an analog or digital wireless receiver, a composite cinch input, a SVHS input, a SCART input, a DVI/HDMI input, or a component input. The input 27 may be used to receive unprocessed images. The electronic device 21 may comprise an output 29, e.g. a wireless transmitter, a composite cinch output, a SVHS output, a SCART output, a DVI/HDMI output, or a component output. The output 29 may be used to output processed images. Alternatively or additionally, the electronic device 21 may comprise a display for outputting processed and/or unprocessed images. The electronic device 21 may be a consumer-electronic device or a professional electronic device, e.g. a server PC.

While the invention has been described in connection with preferred embodiments, it will be understood that modifications thereof within the principles outlined above will be evident to those skilled in the art, and thus the invention is not limited to the preferred embodiments but is intended to encompass such modifications. The invention resides in each and every novel characteristic feature and each and every combination of characteristic features. Reference numerals in the claims do not limit their protective scope. Use of the verb “to comprise” and its conjugations does not exclude the presence of elements other than those stated in the claims. Use of the article “a” or “an” preceding an element does not exclude the presence of a plurality of such elements.

‘Means’, as will be apparent to a person skilled in the art, are meant to include any hardware (such as separate or integrated circuits or electronic elements) or software (such as programs or parts of programs) which perform in operation or are designed to perform a specified function, be it solely or in conjunction with other functions, be it in isolation or in co-operation with other elements. The invention can be implemented by means of hardware comprising several distinct elements, and by means of a suitably programmed computer. ‘Software’ is to be understood to mean any software product stored on a computer-readable medium, such as a floppy disk, downloadable via a network, such as the Internet, or marketable in any other manner.

1. A method of detecting a graphical object in an image, comprising the steps of:
determining (1) a first value of a feature in an object region of the image, the object region possibly containing the graphical object;
determining (3) a second value of the feature in a reference region of the image, the reference region being unlikely to contain the graphical object; and
determining (5) whether the object region contains the graphical object in dependency of a difference between the first value and the second value exceeding a certain threshold.

2. A method as claimed in claim 1, wherein the first value is representative of values of a plurality of pixels in the object region and the object region is determined to contain the graphical object in dependency of a difference between at least a certain amount of said values and the second value exceeding the certain threshold.

3. A method as claimed in claim 2, wherein the object region is determined to contain the graphical object in dependency of a spatial distribution of outliers matching a typical distribution of graphical objects, said outliers being pixels whose values exceed said certain threshold value.

4. A method as claimed in claim 1, wherein the feature is color.

5. A method as claimed in claim 1, wherein the second value represents a probability density function of the reference region.

6. A method as claimed in claim 5, wherein the second value represents a non-parametric probability density function of the reference region.

7. A method as claimed in claim 6, wherein a histogram is used to estimate the probability density function of the reference region.

8. A method as claimed in claim 1, wherein the image comprises at least nine regions, four of the nine regions being corner regions, and the object region comprises at least one of the four corner regions.

9. A method as claimed in claim 1, wherein the second value is determined for a sub region of the reference region, the object region and the sub region being relatively close to each other.

10. Software for making a programmable device operative to perform the method of claim 1.

11. An electronic device (21) for detecting a graphical object in an image, comprising electronic circuitry (23) operative to determine a first value of a feature in an object region of the image, the object region possibly containing the graphical object; to determine a second value of the feature in a reference region of the image, the reference region being unlikely to contain the graphical object; and to determine whether the object region contains the graphical object in dependency of a difference between the first value and the second value exceeding a certain threshold.

12. The electronic circuitry (23) of claim 11.
